(19) United States
(12) Patent Application Publication
(10) Pub. No.: US 2014/0081791 A1
(43) Pub. Date: Mar. 20, 2014

(54) ONLINE GROUP-BUYING METHOD

(71) Applicant: Del Mar Technology Inc., Taipei City (TW)

(72) Inventor: Chung-Shu Jen, Taipei City (TW)

(73) Assignee: Del Mar Technology Inc., Taipei City (TW)

(21) Appl. No.: 13/894,573

(22) Filed: May 15, 2013

(30) Foreign Application Priority Data
Sep. 20, 2012 (TW) 101134497

(51) Int. Cl. G06Q 30/06

(52) U.S. Cl. CPC G06Q 30/0605
USPC 705/26.2

(57) ABSTRACT

In an online group-buying method, a server sends a group-buying invitation message, which includes shop information associated with a seller terminal, to an invitee terminal in an invitee list in response to a group-buying invitation request message from an inviter terminal. Upon receipt of a join message and a purchase order, which is associated with one or more products provided by the seller terminal, from the invitee terminal, the server sends the join message and the purchase order to the inviter terminal. Then, the inviter terminal sends an integrated purchase order, which is generated according to at least the purchase order, to the seller terminal.

### CROSS-REFERENCE TO RELATED APPLICATION

This application claims priority of Taiwanese Application No. 101134497, filed on Sep. 20, 2012.

### BACKGROUND OF THE INVENTION

1. Field of the Invention

The invention relates to an online group-buying method.

2. Description of the Related Art

Typically, online group buying on a group-buying website offers products at a discount price on the condition that a minimum number of buyers would make the purchase. However, it may take much time to set a certain number of buyers to join the online group buying over the Internet because the buyers may not know each other. Thus, it may prolong the wait for confirmation of the online group buying.

### SUMMARY OF THE INVENTION

Therefore, an object of the present invention is to provide an online group-buying method that can overcome the aforesaid drawbacks of the prior art.

According to one aspect of the present invention, there is provided an online group-buying method. The method is implemented by a system that includes a plurality of user terminals, a server capable of communicating with the user terminals through the Internet, and a seller terminal capable of communicating with the user terminals through the Internet. The method comprises the steps of:

a) configuring one of the user terminals that serves as an inviter terminal in online group buying to send through the Internet to the server a group-buying invitation request message and an invitee list, the group-buying invitation request message including shop information which is associated with the seller terminal and at least one product to be sold provided by the seller terminal, the invitee list containing at least another one of the user terminals to be invited by the inviter terminal, said at least another one of the user terminals serving as an invitee terminal in the online group buying;

b) configuring the server to send a group-buying invitation message, which includes the shop information, to the invitee terminal through the Internet in response to the group-buying invitation request message from the inviter terminal;

c) upon receipt of a join message, which is sent from the invitee terminal in response to the group-buying invitation message, by the server through the Internet, configuring the server to forward the join message thus received to the inviter terminal through the Internet in response to the group-buying invitation request message from the inviter terminal;

d) upon receipt of a purchase order, which is associated with said at least one product provided by the seller terminal, corresponds to the join message and is sent from the invitee terminal in response to the group-buying invitation message from the server, by the server through the Internet, configuring the server to forward the purchase order to the inviter terminal through the Internet in response to the group-buying invitation request message from the inviter terminal; and

e) configuring the inviter terminal to generate an integrated purchase order for the online group buying according to at least the purchase order from the server, and to send the integrated purchase order to the seller terminal through the Internet.

According to another aspect of the present invention, there is provided an online group-buying method. The method is implemented by the system, and comprises the steps of:

a) configuring one of the user terminals that serves as an inviter terminal in online group buying to send through the Internet to the server a first group-buying invitation request message and a first invitee list, the first group-buying invitation request message including shop information which is associated with the seller terminal and at least one product to be sold provided by the seller terminal, the first invitee list containing at least another one of the user terminals other than the inviter terminal to be invited by the inviter terminal, said at least another one of the user terminals other than the inviter terminal serving as an invitee terminal in the online group buying;

b) configuring the server to send a first group-buying invitation message, which includes the shop information, to the invitee terminal through the Internet in response to the first group-buying invitation request message from the inviter terminal;

c) configuring the invitee terminal to send a join message to the server through the Internet in response to the first group-buying invitation message from the server;

d) configuring the server to forward the join message thus received to the inviter terminal through the Internet in response to the first group-buying invitation request message from the inviter terminal;

e) configuring the invitee terminal to send a purchase order, which is associated with said at least one product provided by the seller terminal and which corresponds to the join message, to the server through the Internet in response to the first group-buying invitation message from the server;

f) configuring the server to forward the purchase order to the inviter terminal through the Internet in response to the first group-buying invitation request message from the inviter terminal; and

g) configuring the inviter terminal to generate an integrated purchase order for the online group buying according to at least the purchase order from the server, and send the integrated purchase order to the seller terminal through the Internet.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating a system for implementing the preferred embodiment of an online group-buying method according to the present invention;

FIG. 2 is a flow chart illustrating the online group-buying method of the preferred embodiment; and

FIG. 3 is a flow chart illustrating the preferred embodiment when an invitee terminal serves as a sub-inviter terminal.

### DETAILED DESCRIPTION OF THE PREFERRED EMBODIMENT

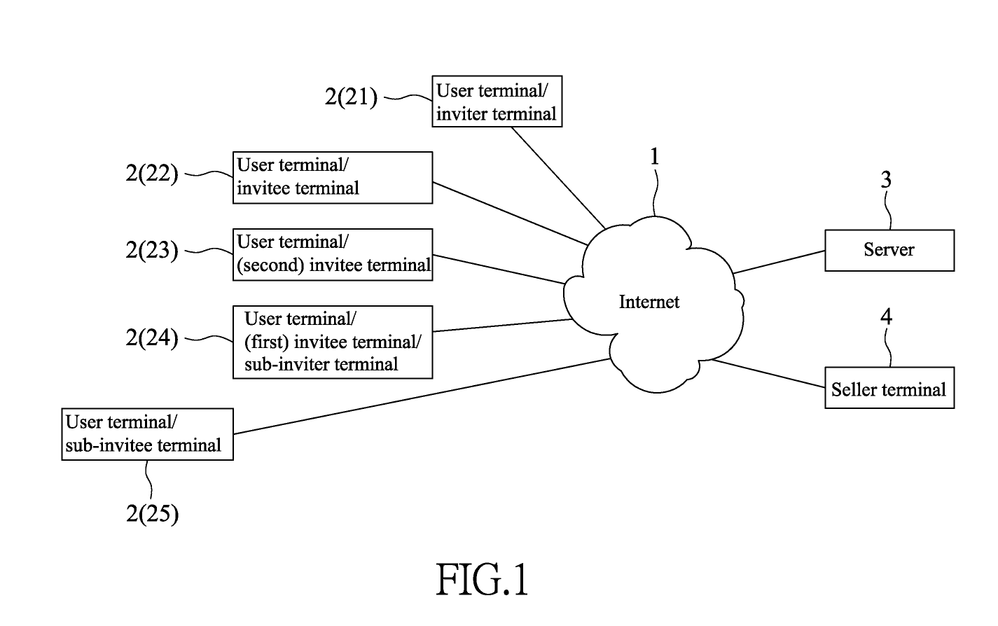

Referring to FIG. 1, a system is configured to implement the preferred embodiment of an online group-buying method according to the present invention. The system includes a plurality of user terminals 2, a server 3 capable of communicating with the user terminals 2 through the Internet 1, and a seller terminal 4 capable of communicating with the user terminals 2 through the Internet 1. In this embodiment, communication between each of the user terminals 2 and the server 3 is based on a session initiation protocol (SIP).

Each of the user terminals 2 can be, but is not limited to, a smartphone, a tablet computer, a desktop computer or a notebook computer. For example, there are five user terminals 2 in the system. In particular, one user terminal 2 serves as an inviter terminal 21 of online group buying to initiate the online group buying, and has a contact list established and stored therein; another three user terminals 2 are associated with the contact list stored in the inviter terminal 21, and serve as invitee terminals 22-24 to be invited by the inviter terminal 21 to the online group buying; one of the three invitee terminals 22-24 further serves as a sub-inviter terminal of the online group buying, and has a contact list established and stored therein; and the remaining one of the user terminals 2 is associated with the contact list stored in the sub-inviter terminal 24, and serves as a sub-invitee terminal 25 to be invited by the sub-inviter terminal 24 to the online group buying. It should be understood that, in other embodiments, the number of the user terminals 2 is not limited to five, and the system may include a number of the user terminals greater or less than five.

The seller terminal 4 can be, but is not limited to, a point of sales (POS) terminal, and provides one or more products to be sold.

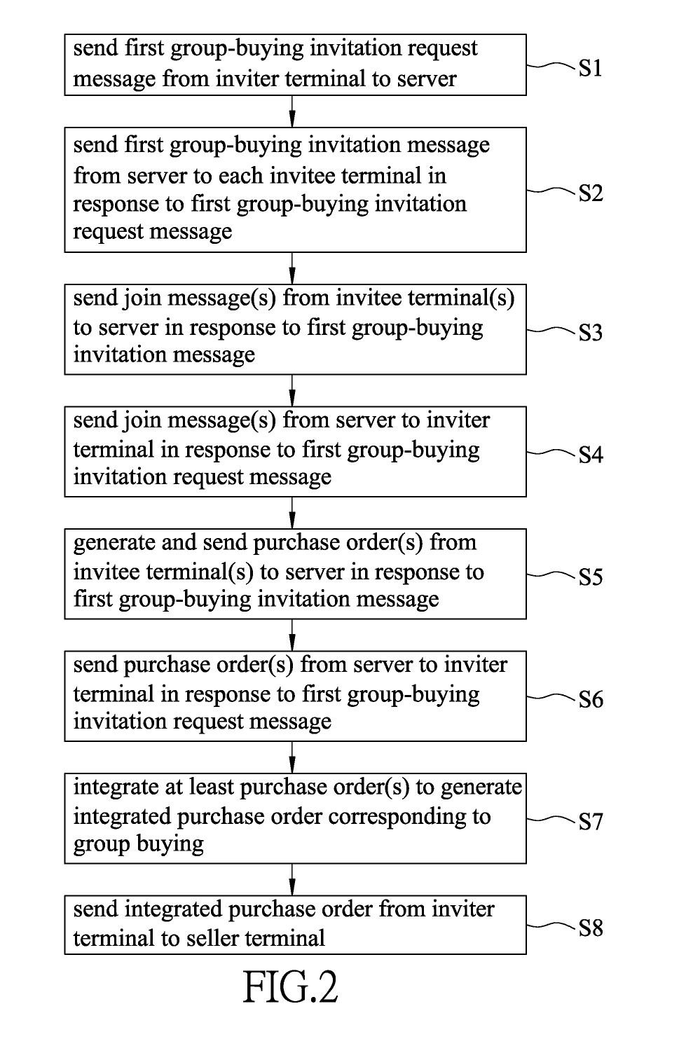

FIG. 2 is a flow chart illustrating steps of the preferred embodiment of the online group-buying method.

In step S1, the inviter terminal 21 is configured to send a first group-buying invitation request message to the server 3 through the Internet 1. The first group-buying invitation request message includes shop information, and a first invitee list. The shop information is associated with the seller terminal 4 and at least one product to be sold provided by the seller terminal 4. In this embodiment, the shop information includes uniform resource locator (URL) information for indicating a location of the seller terminal 4, and/or product information corresponding to the product provided by the seller terminal 4. The first invitee list is associated with at least a part of the content of the contact list stored in the inviter terminal 21. In other words, the first invitee list contains the three invitee terminals 22-24, which are included in the contact list stored in the inviter terminal 21.

In step S2, upon receipt of the first group-buying invitation request message from the inviter terminal 21 through the Internet 1, the server 3 is configured to send a first group-buying invitation message to each of the three invitee terminals 22-24 through the Internet 1 in response to the first group-buying invitation request message from the inviter terminal 21. The first group-buying invitation message includes the shop information.

When the first group-buying invitation message is received by the three invitee terminals 22-24 through the Internet 1, users of the three invitee terminals 22-24 can decide whether or not to join the online group buying initiated by the inviter terminal 21. In this embodiment, for example, the users of two of the three invitee terminals 23, 24 (hereinafter called as a first invitee terminal 24 and a second invitee terminal 23) have decided to join the online group buying.

In step S3, when the users of the first and second invitee terminals 24, 23 decide to join the online group buying, each of the first and second invitee terminals 24, 23 is configured to send a join message to the server through the Internet 1 in response to the first group-buying invitation message from the server 3.

In step S4, upon receipt of the join messages respectively from the first and second invitee terminals 24, 23 through the Internet 1, the server 3 is configured to forward the join messages thus received to the inviter terminal 21 through the Internet 1 in response to the first group-buying invitation request message from the inviter terminal 21.

In this case, the users of the first and second invitee terminals 24, 23 can optionally decide whether or not to generate a purchase order, as desired, for the product to be sold by the seller terminal 4.

In step S5, each of the first and second invitee terminals 24, 23 is configured to generate the purchase order corresponding to the join message, and is configured to send the purchase order through the Internet 1 to the server 3 in response to the first group-buying invitation message from the server 3.

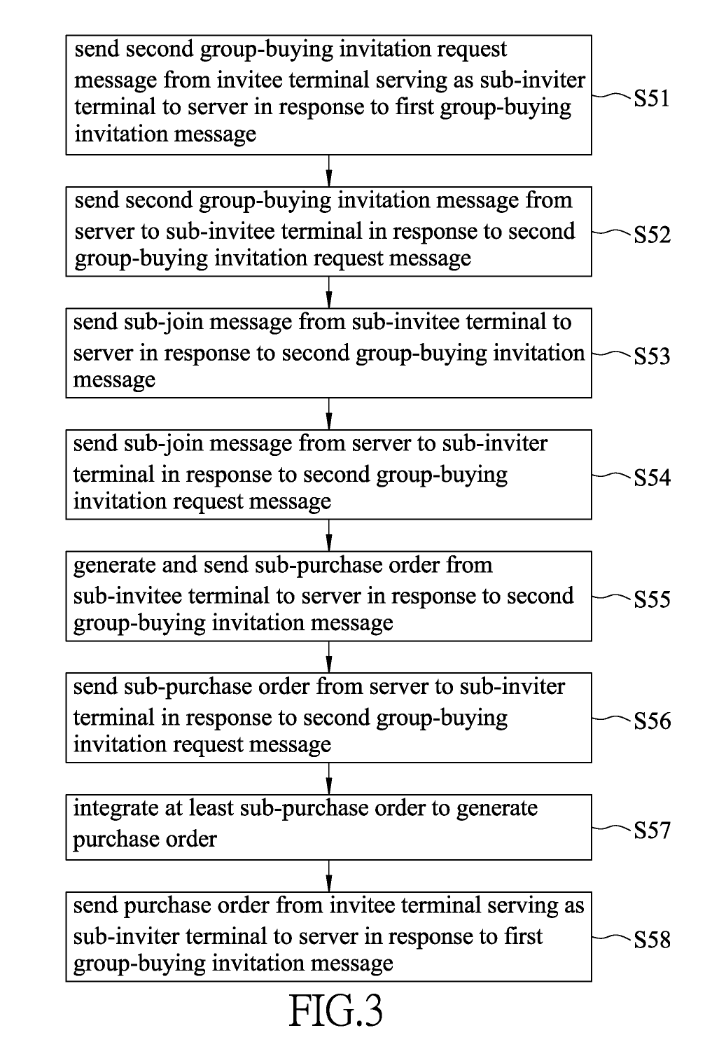

In addition, it can be further optionally decided whether each of the first and second invitee terminals 24, 23 will serve as the sub-inviter terminal by its user. For example, if the first invitee terminal 24 is decided to serve as the sub-inviter terminal, step S5 further includes the following sub-steps for the first invitee terminal 24 as illustrated in FIG. 3.

In sub-step S51, the sub-inviter terminal 24 (i.e., the first invitee terminal 24) is configured to send a second group-buying invitation request message to the server 3 through the Internet 1. The second group-buying invitation request message includes the shop information, and a second invitee list. The second invitee list is associated with at least a part of the content of the contact list stored in the sub-inviter terminal 24. In other words, the second invitee list contains the sub-invitee terminal 25 that is included in the contact list stored in the sub-inviter terminal 24.

In sub-step S52, the server 3 is configured to send a second group-buying invitation message to the sub-invitee terminal 25 through the Internet 1 in response to the second group-buying invitation request message from the sub-inviter terminal 24. The second group-buying invitation message includes the shop information.

Similarly, when the second group-buying invitation message is received by the sub-invitee terminal 25 through the Internet 1, a user of the sub-invitee terminal 25 can optionally decide whether or not to join the online group buying. In this embodiment, for example, the user of the sub-invitee terminal 25 has decided to join the online group buying.

In sub-step S53, the sub-invitee terminal 25 is configured to send a sub-join message to the server 3 through the Internet 1 in response to the second group-buying invitation message from the server 3.

In sub-step S54, upon receipt of the sub-join message from the sub-invitee terminal 25 through the Internet 1, the server 3 is configured to forward the sub-join message thus received to the sub-inviter terminal 24 through the Internet 1 in response to the second group-buying invitation request message from the sub-inviter terminal 24.

In this case, the user of the sub-invitee terminal 25 can optionally decide whether or not to generate a sub-purchase order, as desired, for the product to be sold by the seller terminal 4.

In sub-step S55, the sub-invitee terminal 25 is configured to generate and send the sub-purchase order corresponding to the sub-join message to the server 3.

In sub-step S56, upon receipt of the sub-purchase order from the sub-invitee terminal 25 through the Internet 1, the server 3 is configured to forward the sub-purchase order to the sub-inviter terminal 24 through the Internet 1 in response to the second group-buying invitation request message from the sub-inviter terminal 24.

In sub-step S57, the sub-inviter terminal 24 is configured to integrate at least the sub-purchase order to generate the purchase order. For example, the purchase order finally generated by the sub-inviter terminal 24 can be integrated with the sub-purchase order desired by the user of the sub-invitee terminal 25 and an original purchase order desired by the user of the sub-inviter terminal 24.

In sub-step S58, the sub-inviter terminal 24 (i.e., the first invitee terminal 24) is configured to send the purchase order generated in step S57 to the server through the Internet 1 in response to the first group-buying invitation message from the server 3.

Then, referring once again to FIG. 2, in step S6, upon receipt of the purchase order from each of the first and second invitee terminals 24, 23 generated in step S5 through the Internet 1, the server 3 is configured to forward the purchase order thus received to the inviter terminal 21 through the Internet 1 in response to the first group-buying invitation request message from the inviter terminal 21. It is noted that, in this embodiment, the purchase orders respectively from the first and second invitee terminals 24, 23 are preferably sent to the inviter terminal 21 within a predetermined time period from the time when the inviter terminal 21 sends the first group-buying invitation request message in step S1.

In step S7, the inviter terminal 21 is configured to integrate at least the purchase orders that are received from the server 3 and that are generated respectively by the first and second invitee terminals 24, 23, so as to generate an integrated purchase order for the online group buying. For example, the integrated purchase order generated by the inviter terminal 21 is integrated with the purchase orders generated respectively by the first and second invitee terminals 24, 23, or the integrated purchase order generated by the inviter terminal 21 is integrated with the purchase orders generated respectively by the first and second invitee terminals 24, 23 and another purchase order desired by the user of the inviter terminal 21.

In step S8, the inviter terminal 21 is configured to send the integrated purchase order to the seller terminal 4 through the Internet 1. In this embodiment, the integrated purchase order is directly sent from the inviter terminal 21 to the seller terminal 4 through the Internet 1. Alternatively, the integrated purchase order can be sent to the seller terminal 4 via the server 3. In this case, the integrated purchase order can be temporarily stored in the server 3.

In view of the above, since the first invitee list provided by the inviter terminal 21 is associated with the contact list stored in the inviter terminal 21, there generally exists a social relationship between the user of the inviter terminal 21 and the user (s) of the invitee terminal(s) 22-24. Likewise, since the second invitee list provided by the sub-inviter terminal 24 is associated with the contact list stored in the sub-inviter terminal 24, there generally exists a social relationship between the user of the sub-inviter terminal 24 and the user (s) of the sub-invitee terminal (s) 25. Therefore, the online group-buying method of this invention can efficiently achieve group buying using social relationships among the users of the user terminals 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An online group-buying method to be implemented by a system that includes a plurality of user terminals, a server capable of communicating with the user terminals through the Internet, and a seller terminal capable of communicating with the user terminals through the Internet, said online group-buying method comprising the steps of:
a) configuring one of the user terminals that serves as an inviter terminal in online group buying to send through the Internet to the server a group-buying invitation request message and an invitee list, the group-buying invitation request message including shop information which is associated with the seller terminal and at least one product to be sold provided by the seller terminal, the invitee list containing at least another one of the user terminals to be invited by the inviter terminal, said at least another one of the user terminals serving as an invitee terminal in the online group buying;
b) configuring the server to send a group-buying invitation message, which includes the shop information, to the invitee terminal through the Internet in response to the group-buying invitation request message from the inviter terminal;
c) upon receipt of a join message, which is sent from the invitee terminal in response to the group-buying invitation message, by the server through the Internet, configuring the server to forward the join message thus received to the inviter terminal through the Internet in response to the group-buying invitation request message from the inviter terminal;
d) upon receipt of a purchase order, which is associated with said at least one product provided by the seller terminal, corresponds to the join message and is sent from the invitee terminal in response to the group-buying invitation message from the server, by the server through the Internet, configuring the server to forward the purchase order to the inviter terminal through the Internet in response to the group-buying invitation request message from the inviter terminal; and
e) configuring the inviter terminal to generate an integrated purchase order for the online group buying according to at least the purchase order from the server, and to send the integrated purchase order to the seller terminal through the Internet.

2. The online group-buying method as claimed in claim 1, wherein the invitee list is associated with a contact list established and stored in the inviter terminal.

3. The online group-buying method as claimed in claim 1, wherein the shop information includes uniform resource locator (URL) information for indicating a location of the seller terminal.

4. The online group-buying method as claimed in claim 1, wherein the shop information includes product information corresponding to said at least one product.

5. The online group-buying method as claimed in claim 1, wherein, in step d), the purchase order is sent to the inviter terminal within a predetermined time period from the time when the inviter terminal sends the group-buying invitation request message in step a).

6. An online group-buying method to be implemented by a system that includes a plurality of user terminals, a server capable of communicating with the user terminals through the Internet, and a seller terminal capable of communicating with the user terminals through the Internet, said method comprising the steps of:
a) configuring one of the user terminals that serves as an inviter terminal in online group buying to send through the Internet to the server a first group-buying invitation request message and a first invitee list, the first group-buying invitation request message including shop information which is associated with the seller terminal and at least one product to be sold provided by the seller terminal, the first invitee list containing at least another one of the user terminals other than the inviter terminal to be invited by the inviter terminal, said at least another one of the user terminals other than the inviter terminal serving as an invitee terminal in the online group buying;
b) configuring the server to send a first group-buying invitation message, which includes the shop information, to the invitee terminal through the Internet in response to the first group-buying invitation request message from the inviter terminal;
c) configuring the invitee terminal to send a join message to the server through the Internet in response to the first group-buying invitation message from the server;
d) configuring the server to forward the join message thus received to the inviter terminal through the Internet in response to the first group-buying invitation request message from the inviter terminal;
e) configuring the invitee terminal to send a purchase order, which is associated with said at least one product provided by the seller terminal and which corresponds to the join message, to the server through the Internet in response to the first group-buying invitation message from the server;
f) configuring the server to forward the purchase order to the inviter terminal through the Internet in response to the first group-buying invitation request message from the inviter terminal; and
g) configuring the inviter terminal to generate an integrated purchase order for the online group buying according to at least the purchase order from the server, and send the integrated purchase order to the seller terminal through the Internet.

7. The online group-buying method as claimed in claim 6, wherein the first invitee list is associated with a contact list established and stored in the inviter terminal.

8. The online group-buying method as claimed in claim 6, wherein the shop information includes URL information for indicating a location of the seller terminal.

9. The online group-buying method as claimed in claim 6, wherein the shop information includes product information corresponding to said at least one product.

10. The online group-buying method as claimed in claim 6, wherein, in step f), the purchase order is sent to the inviter terminal within a predetermined time period from the time when the inviter terminal sends the first group-buying invitation request message in step a).

11. The online group-buying method as claimed in claim 6, wherein step e) further includes the sub-steps of:
e-1) configuring the invitee terminal that serves as a sub-inviter terminal to send through the Internet to the server a second group-buying invitation request message and a second invitee list, the second group-buying invitation request message including the shop information, the second invitee list containing at least yet another one of the user terminals other than the sub-inviter terminal to be invited by the sub-inviter terminal, said at least yet another one of the user terminals serving as a sub-invitee terminal in the online group buying;
e-2) configuring the server to send a second group-buying invitation message, which includes the shop information, to the sub-invitee terminal through the Internet in response to the second group-buying invitation request message from the sub-inviter terminal;
e-3) upon receipt of a sub-join message, which is sent from the sub-invitee terminal in response to the second group-buying invitation message, by the server through the Internet, configuring the server to forward the sub-join message thus received to the sub-inviter terminal through the Internet in response to the second group-buying invitation request message from the sub-inviter terminal;
e-4) upon receipt of a sub-purchase order, which is associated with said at least one product, corresponds to the sub-join message and is sent from the sub-invitee terminal in response to the second group-buying invitation message from the server, by the server through the Internet, configuring the server to forward the sub-purchase order to the sub-inviter terminal through the Internet in response to the second group-buying invitation request message from the sub-inviter terminal; and
e-5) configuring the sub-inviter terminal to generate the purchase order according to at least the sub-purchase order, and to send the purchase order to the server through the Internet in response to the first group-buying invitation message from the server.

12. The online group-buying method as claimed in claim 11, wherein the second invitee list is associated with a contact list established and stored in the sub-inviter terminal.
